(19) United States
(12) Patent Application Publication
(10) Pub. No.: US 2008/0291971 A1
(43) Pub. Date: Nov. 27, 2008

(54) Method and Transmitter, Receiver and Transceiver Systems for Ultra Wideband Communication

(75) Inventors: Francois Chin Po Shin, Singapore (SG); Appukuttan Nair Saraswathy Amma Madhukumar, Singapore (SG)

Correspondence Address: CONLEY ROSE, P.C.;David A. Rose, P. O. BOX 3267, HOUSTON, TX, 77253-3267, US

(73) Assignee: AGENCY FOR SCIENCE, TECHNOLOGY AND RESEARCH, Singapore (SG)

(21) Appl. No.: 10/597,342

(22) PCT Filed: Jan. 20, 2004
(86) PCT No.: PCT/SG2004/000022

§ 371 Date: Aug. 12, 2008

(51) Int. Cl. H04B 1/69

(52) U.S. Cl. 375/130

(57) ABSTRACT

A transmitter for transmitting data as a pulsed ultrawide band signal comprises a serial-to-parallel converter (54) for converting the signal to be transmitted to a parallel sequence, a modulator (64) to convert the parallel sequence to a parallel stream of impulse trains. A delay unit (60) delays the parallel streams of impulse trains by different time intervals within the same pulse repetition period. The delayed pulse streams are combined so that the pulses in the streams occur within the pulse repetition period of a single pulse. An antenna (52) is used to transmit the combined signal. A receiver comprises an antenna (72) for receiving a transmitted pulsed ultrawide band signal having two or more interleaved pulse trains with equal pulse repetition periods, the pulse repetition period being greater than the pulse spacing in the interleaved signal. A matched filter filters the received signal, the filter being matched to the pulse shape of the received signal. A low-pass filter (74) is coupled to the matched filter and an analogue-to-digital converter (76) is coupled thereto. A serial-to-parallel conversion unit (78) is coupled to the converter (76) to sample the digital signal at a rate greater than the pulse repetition frequency of the received signal. A signal processor (80) is coupled to the serial-to-parallel conversion unit (78) to produce an output signal representative of the received data.

### FIELD OF INVENTION

The present invention relates to a method and transmitter, receiver and transceiver systems for ultra wideband communication, such as an ultra wideband radio system.

### BACKGROUND

Most conventional radio systems are bandwidth limited, trading power to improve the data rate. In accordance with Shannon's criteria for channel capacity, the transmission power required to achieve satisfactory performance in a radio system increases exponentially with data rate, thereby limiting the possible data transmission rate for band-limited systems. To overcome this problem, ultra-wideband (UWB) systems have been proposed in which the channel capacity scales almost linearly with bandwidth. UWB communication systems are based on the generation and transmission of very short pulses, in the range of a few tens of picoseconds or a few nanoseconds, with a bandwidth of a few Giga Hertz.

In conventional communication systems, the arrival of reflected waves via different path lengths causes constructive and destructive interference at the receiver, degrading the system's performance. In systems using very short pulses, such as in UWB systems, these reflected waves are received without interfering with each other. However, in such systems, the propagation characteristics of high-rate UWB transmission show that the dispersion is too great and may cause interference with adjacent UWB pulses, but the short transmission pulses in such systems are relatively immune to multipath effects.

In UWB systems, a very high data rate can be supported, due to the large bandwidth, but the power spectral density of UWB transmission is extremely low, even below the noise level. The total power emitted is a fraction of a milliwatt. The Federal Communications Commission (FCC) has approved UWB applications to operate in the unlicensed bands, but has specified stringent spectral limits when the UWB spectrum overlaps conventional narrowband devices. This ensures that the UWB devices will not significantly interfere with typical wireless devices.

Designing a transceiver structure for such high-rate systems, with unlimited bandwidth is a challenging task. Complex design issues relating to both radio frequency (RF) and baseband signal processing at the transmitter and the receiver must be considered.

To achieve high data rate and improved bit error rate performance, conventional communication transmitters and receivers typically use diversity techniques. In diversity combining, the receiver can obtain multiple copies of the same transmitted waveform that had traversed diverse paths and combine them together to give improved performance.

There are different ways to obtain many independent replicas of the same signal, based on time, frequency and space. In time diversity, the same signal is transmitted many (say k) times, with time separations larger than the coherent time of the channel. This approach expands the required bandwidth by k and the delay is (k−1) times the coherence time. However, this kind of repeat transmission scheme is highly impractical for many systems, due to the potentially high data rates. Moreover, high rate communication systems have a significantly higher number of paths and so may not give much improvement in system performance, considering system capacity and resource allocation.

In frequency diversity, the same signal is transmitted using N different frequencies, with frequency separations larger than the coherent bandwidth of the channel. This approach also expands the required bandwidth by N and it requires extra circuitry for the (N−1) modulators and demodulators if the data stream is transmitted in serial mode. To keep the constant data rate with alternative arrangements, the incoming data is streamed into several (in this case, N) parallel data channels, each of which is replicated to k frequency bands to attain the required frequency diversity order of k.

The most popular diversity method is space diversity, in which many transmitter and receiver antennae are spaced at separations larger than the coherence distance of the channel. This arrangement will improve the system capacity and BER performance of the communication system. The number of transmitter antennae will depend on the level of transmission diversity the system requires. The extra cost in space diversity is the additional RF circuitry and associated complexity for each antenna. This transmission diversity combining method is termed as multiple input-multiple output (MIMO) diversity combining.

FIG. 1(a) shows an example of a conventional RF transceiver structure for MIMO combining. The transceiver comprises a transmitter having an array of M transmitting antennae 2, each antenna having its own drive system (not shown). The receiver includes an array of N receiving antennae 3 to obtain a receiver diversity of N. Each receiving antenna includes a local oscillator 4 and an analogue-to-digital converter (ADC) 8. To have an effective MIMO detection at the receiver, the transmitter can have a maximum of M transmitting antennae 2, provided that M<N. All the antennae 2, 3 are tuned to the same centre frequency. The outputs from the individual ADCs 8 are passed to signal processing circuits (not shown) where the data are recovered.

The diversity combining methods discussed above are severely limited for systems with comparatively low data rates. When the data rate is increased, the number of resolvable multipaths increases considerably. Due to resource limitations, the receiver hardware cannot process all multipath components satisfactorily. This limitation will increase the multipath interference and considerably affect the system capacity.

As mentioned above, using re-transmissions to obtain time and frequency diversities are highly impractical for high rate systems due to the limited available resources. Moreover, these systems are highly inefficient in terms of bandwidth efficiency.

Among the different conventional methods available for diversity combining, space diversity is considered the most popular method. Space diversity has several advantages over other diversity methods. However, it requires multiple antennae at the receiver and transmitter and is more suitable for base stations due to the size and complexity constraints of mobile stations. If multiple antennae are used at the receiver, multiple receiver filters will be required, as well as local oscillators (LO) and ADCs, thereby increasing the cost, size and complexity of the receivers. The presence of multiple ADCs necessitates block synchronisation across ADCs, which is not a trivial task. Furthermore, the problems with multipath interference at high data rate and multi-stream interference across antennae are the major issues for systems with space diversity.

The introduction of UWB radio technology for high-speed Wireless Personal Area Networks (WPAN) is being investigated in this context. UWB technology uses ultra wideband pulses with a low duty cycle to achieve higher data rates. Incorporating space diversity in the transceiver structure can increase the data rate further, but the above limitations for space diversity are applicable for UWB systems as well. These limitations are more significant for UWB systems, mainly because of the cost, complexity and size constraints of WPAN devices.

Thus the limitations of using conventional diversity methods at high data rates and the potential demand of ultra wideband transceiver structures, necessitates the development of a new diversity method for ultra high data rates without significant increase in system complexity.

### SUMMARY OF INVENTION

In general terms, the present invention proposes a transceiver system with staggered transmission at the transmitter to achieve transmission diversity using, for example, a single antenna and oversampling at the receiver.

According to a first aspect of the invention there is provided a transmitter system for transmitting data as a pulsed ultrawide band signal comprising:
a converter for converting a signal to be transmitted from a serial sequence to a parallel sequence;
a modulator to convert said parallel sequence to a parallel stream of impulse trains, each train having a pulse repetition period;
a delay unit to delay said parallel streams of impulse trains by different time intervals within the same pulse repetition period;
a signal combining unit to combine the delayed pulse streams to form a combined signal so that the pulses in the streams occur within the pulse repetition period of a single pulse;
a pulse generator to form a pulse sequence based on said combined signal; and
an antenna for transmitting said pulse sequence.

According to a second aspect of the invention there is provided a receiver system for receiving data as a pulsed ultrawide band signal comprising:
a receiving antenna for receiving said pulsed ultrawide band signal, said pulsed signal having a pulse shape, a bandwidth, a pulse width, and a pulse repetition frequency, said pulsed signal comprising two or more interleaved pulse trains having equal pulse repetition periods, said interleaved pulse trains being spaced by a pulse spacing, said pulse repetition period being greater than said pulse spacing;
a matched filter coupled to said antenna for filtering said received signal to form a filtered signal, said filter being matched to the pulse shape of said received signal;
a low-pass filter coupled to said matched filter to process said filtered signal to form a processed signal;
an analogue-to-digital converter coupled to said low-pass filter to convert, at a rate greater than the pulse repetition frequency of said received signal, said processed signal from an analogue signal to a digital signal;
a serial-to-parallel conversion unit coupled to said converter to convert said digital signal to produce N parallel sampled signals; and
a signal processor coupled to said serial-to-parallel conversion unit to produce an output signal representative of said received data.

According to a third aspect of the present invention there is provided a transceiver system comprising a transmitter for transmitting data as a pulsed ultrawide band signal comprising:
a converter for converting a signal to be transmitted from a serial sequence to a parallel sequence;
a modulator to convert said parallel sequence to a parallel stream of impulse trains, each train having a pulse repetition period;
a pulse generator to drive said modulator;
a delay unit to delay said parallel streams of impulse trains by different time intervals within the same pulse repetition period;
a signal combining unit to combine the delayed pulse streams to form a combined signal so that the pulses in the streams occur within the pulse repetition period of a single pulse; and
   an antenna for transmitting said combined signal, said transceiver system further comprising:
a receiver for receiving data as a pulsed ultrawide band signal comprising:
a receiving antenna for receiving said pulsed ultrawide band signal, said pulsed signal having a pulse shape, a bandwidth, a pulse width, and a pulse repetition frequency, said pulsed signal comprising two or more interleaved pulse trains having equal pulse repetition periods, said interleaved pulse trains being spaced by a pulse spacing, said pulse repetition period being greater than said pulse spacing;
a matched filter coupled to said antenna for filtering said received signal to form a filtered signal, said filter being matched to the pulse shape of said received signal;
a low-pass filter coupled to said matched filter to process said filtered signal to form a processed signal;
an analogue-to-digital converter coupled to said low-pass filter to convert said processed signal from an analogue signal to a digital signal;
a serial-to-parallel conversion unit coupled to said converter to sample said digital signal at a rate greater than the pulse repetition frequency of said received signal and to produce a sampled signal; and
a signal processor coupled to said serial-to-parallel conversion unit to produce an output signal representative of said received data.

According to further aspects of the invention there is provided a DS-CDMA system comprising the transmitter, and/or receiver, and/or transceiver defined above.

According to yet a further aspect of the invention there is provided a method for transmitting data as a pulsed ultrawide band signal comprising:
converting in a serial-to-parallel converter a signal to be transmitted from a serial sequence to a parallel sequence;
converting in a modulator said parallel sequence to a parallel stream of impulse trains, each train having a pulse repetition period;
delaying said parallel streams of impulse trains by different time intervals within the same pulse repetition period;
combining the delayed pulse streams to form a combined signal so that the pulses in the streams occur within the pulse repetition period of a single pulse; and
transmitting said combined signal.

According to a further aspect of the invention there is provided a method for receiving data as a pulsed ultrawide band signal comprising:
receiving said pulsed ultrawide band signal, said pulsed signal having a pulse shape, a bandwidth, a pulse width, and a pulse repetition frequency, said pulsed signal comprising two or more interleaved pulse trains having equal pulse repetition periods, said interleaved pulse trains being spaced by a pulse spacing, said pulse repetition period being greater than said pulse spacing;
filtering in a matched filter said received signal to form a filtered signal, said filter being matched to the pulse shape of said received signal;
processing in a low-pass filter coupled to said matched filter said filtered signal to form a processed signal;
converting said processed signal from an analogue signal to a digital signal;
serial-to-parallel converting said digital signal at a rate greater than the pulse repetition frequency of said received signal and to produce a sampled signal; and
processing said sampled signal to produce an output signal representative of said received data.

Preferred embodiments of the invention introduce diversity gains at both the transmitter and the receiver and this helps to improve the system capacity.

In a preferred embodiment, code division multiple access technology may be used to handle multiple accesses. Selecting a higher modulation system such as QPSK may increase data transmission rate.

In a preferred embodiment, a multi-band transmitter based on a local oscillator for UWB transmission is proposed. The multi-band transmitter system allows the user to select bands with lower interference and to ignore the bands used by existing wireless standards. The multi-band system may considerably reduce interference between UWB systems and improve coexistence with multiple wireless devices.

Hence, it is an aim of an embodiment of the present invention to have a relatively simple RF structure, with the possibility of exploiting space diversity, but without using multiple antennae at both the transmitter and receiver.

### BRIEF DESCRIPTION OF DRAWINGS

Preferred features of the invention will now be described, for the sake of illustration only, with reference to the following Figures in which:

FIG. 1 is a schematic diagram of a conventional RF transceiver structure with space diversity;

FIG. 2(a) is a waveform of an example of a pulse sequence generated by a UWB transmitter;

FIG. 2(b) is a waveform of an example of a received UWB pulse corresponding to a transmitted pulse without channel distortion;

FIG. 3(a) is a schematic block diagram of a conventional pulse generator corresponding to BPSK modulation;

FIG. 3(b) is a schematic block diagram of a pulse generator using QPSK modulation in accordance with an embodiment of invention;

FIG. 4(a) is a schematic block diagram of an alternative transmitter structure with a quadrature mixer for multi-band transmission in accordance with an embodiment of invention;

FIG. 4(b) illustrates the waveforms at different stages of the alternative transmitter structure shown in FIG. 4(a) with a quadrature mixer for multi-band transmission;

FIG. 5 is an example of the frequency allocation for multiple bands in the alternative transmitter structure of FIG. 4(a) with a quadrature mixer for multi-band transmission;

FIG. 6(a) is a schematic block diagram of a conventional transmitter structure with multiple transmitting antennae;

FIG. 6(b) is a schematic block diagram of a staggered transmitter in accordance with an embodiment of invention;

FIG. 6(c) is a schematic block diagram of an alternative staggered transmitter in accordance with an embodiment of invention;

FIG. 7 is an illustration of waveforms in a staggered transmission stream;

FIG. 8 is a schematic block diagram of an oversampling receiver in accordance with an embodiment of invention;

FIG. 9(a) is a schematic block diagram of a baseband signal-processing unit in accordance with the embodiment of invention shown in FIG. 8;

FIG. 9(b) is a schematic block diagram of the n-th MultiTap unit of baseband signal-processing unit of FIG. 9(a);

FIG. 9(c) is a schematic block diagram of the vector multiplier (M) unit of FIG. 9(a);

FIG. 10 is a table illustrating an example of multipath channel characteristics and corresponding model parameters for the simulation studies of systems including systems according to an embodiment of the present invention;

FIG. 11 is a table describing the system parameters for simulation studies of a system according to an embodiment of the present invention;

FIG. 12(a) is a graph illustrating the performance of an embodiment of the present invention with an oversampling factor of 32 and RLS equalizer with two delay taps in a channel model for 0-4 meter line of sight (LOS) propagation conditions;

FIG. 12(b) is a graph illustrating the performance of an embodiment of the present invention with an oversampling factor of 32 and RLS equalizer with two delay taps in a channel model for 4-10 meter non-line of sight (NLOS) propagation conditions;

FIG. 13(a) is a graph illustrating the performance of an embodiment of the present invention with an oversampling factor of 16 and RLS equalizer with four delay taps in a channel model for 0-4 meter line of sight (LOS) propagation conditions;

FIG. 13(b) is a graph illustrating the performance of an embodiment of the present invention with an oversampling factor of 16 and RLS equalizer with four delay taps in a channel model for 4-10 meter non-line of sight (NLOS) propagation conditions;

FIG. 14(a) is a graph illustrating the performance of an embodiment of the present invention with an oversampling factor of 16 and RLS equalizer with two delay taps in a channel model for 0-4 meter line of sight (LOS) propagation conditions;

FIG. 14(b) is a graph illustrating the performance of an embodiment of the present invention with an oversampling factor of 16 and RLS equalizer with two delay taps in a channel model for 4-10 meter non-line of sight (NLOS) propagation conditions;

FIG. 15(a) is a graph illustrating the performance comparison of an embodiment of the present invention with different receiver parameters for different oversampling (OS) factors; and

FIG. 15(b) is a graph illustrating the performance comparison of an embodiment of the present invention with different receiver parameters for different delay taps (DT).

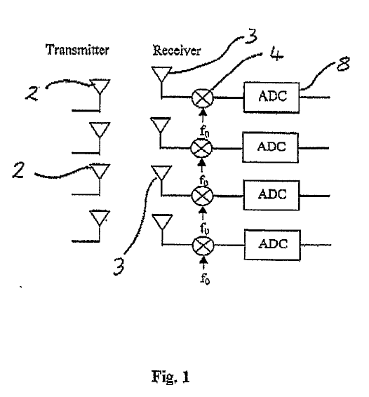

### DETAILED DESCRIPTION OF INVENTION

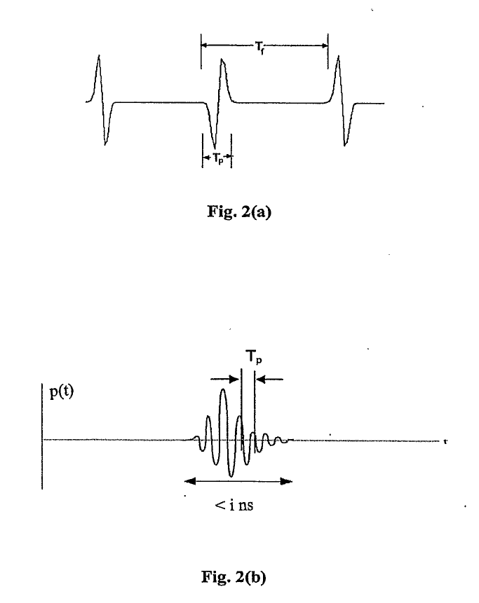

The present invention will be described in connection with FIGS. 2a to 15(b).

A preferred embodiment of the present invention uses ultra wideband (UWB) pulses for transmitting information. In general, UWB systems transmit sequences of information carried on very narrow width (Tₚ) pulses that are spaced at regular intervals depending on the modulation. These pulses can be formed using a single basic pulse shape generator and are very short in duration, typically much shorter than the interval corresponding to a single bit or chip. The interval between two adjacent pulses is called the pulse repetition period (T_{f}).

FIG. 2(a) shows an example waveform of a pulse sequence generated by a UWB transmitter, for example, in an embodiment according to the present invention. A stream of pulses is shown, each pulse comprising a positive and negative excursion. The order in which the said excursions occur indicates the level of the data pulse being passed through the transceiver. FIG. 2(a) illustrates the relation between pulse repetition period (T_{f}) and pulse width (Tₚ). The pulse width (Tₚ) is defined as the duration of both excursions and the pulse repetition period (T_{f}) is defined as the time from the start of one pulse to the start of the next pulse.

The transmitter structure embodying the present invention exploits the use of this mark/space feature of the transmitted pulse streams and combines many parallel streams of transmitter pulses together in a staggered manner. The maximum number of parallel transmitted pulse streams possible for the staggered combining is limited by the ratio of pulse repetition period (T_{f}) to pulse width (Tₚ), which is also defined as the inverse of the duty cycle.

The shape of the transmitted pulse will change significantly as it passes through the wireless channel and antennae at a transmitter and a receiver.

FIG. 2(b) shows the typical shape of the waveform received at the receiver when a UWB pulse is transmitted and has not suffered any channel distortion. As shown in FIG. 2(b), the received pulse resembles a ringing or oscillating pattern, having a roughly equal duration of positive and negative excursions. This excursion period plays an important part and may be termed as the pulse width (Tₚ), as is denoted in FIG. 2(b).

It has been appreciated from an analysis of the waveform of FIG. 2(b), that a particularly advantageous way to recover the signal is to use a filter matched to the received pulse shape. An efficient and practical implementation for such a receiver matched filter is a sinusoidal waveform, which is essentially a local oscillator (LO) having a centre frequency equal to the inverse of the pulse width (1/Tₚ), followed by a low-pass filter of roughly the same bandwidth. In practice, this type of local oscillator (LO) may introduce a timing mismatch, which can be compensated by using a quadrature pair of local oscillators.

Based on the above considerations, a preferred embodiment of the invention includes a structure using receivers of the quadrature mixer type.

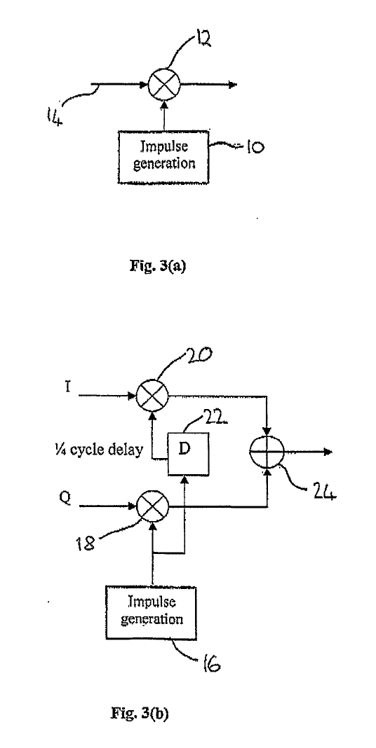

FIGS. 3(a) and 3(b) compare the details of pulse generation for a typical conventional method and an embodiment of the present invention. FIG. 3(a) shows the impulse generator module for a conventional BPSK system. The system of FIG. 3(a) comprises a pulse generator 10 which drives a modulator unit 12 to convert an incoming data stream 14 into a stream of pulses which is then passed to an antenna drive unit (not shown).

FIG. 3(b) shows a pulse generation system according to an embodiment of the present invention using QPSK modulation. The system of FIG. 3(b) comprises a pulse generator 16 which drives two modulator units 18, 20. One of the modulator units 18 directly operates on the quadrature data stream Q and the other modulator unit 20 operates on the in-phase data stream 1, via a delay unit 22. The outputs of the two modulator units 18, 20 are then multiplexed in an antenna drive unit 24 and passed to an antenna (not shown). The delay D is selected as ¼ of the pulse width for QPSK modulation.

By selecting QPSK for data modulation, the data rate may be increased by a factor of two for the same number of transmission streams. When using QPSK modulation, two identical transmitter branches will generate the pulses for I-phase and Q-phase data which are added together before transmission.

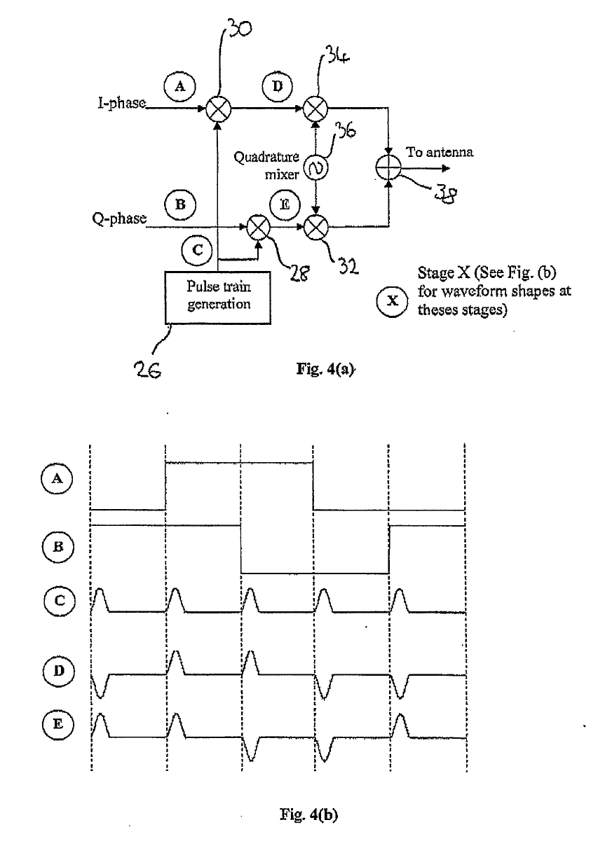

FIG. 4(a) shows a block diagram for a local oscillator based multi-band transmitter unit embodying the present invention. The unit comprises a pulse generator 26 for driving two modulator units 28, 30. One of the modulator units 28 directly operates on the quadrature data stream Q and the other modulator unit 30 operates on the in-phase data stream I. The output of each modulator unit 28, 30 is passed through a respective quadrature mixer 32, 34. The quadrature mixers 32, 34 are driven by a local oscillator 36 before being multiplexed in an antenna drive unit 38.

As the preferred system illustrated in FIG. 4(a) uses a quadrature mixer type of local oscillator 36 which produces QPSK modulated signals, the pulse generator is simple and can use any pulse shaping function instead of monoshots. A typical example is Gaussian pulses. The characteristics of the pulses will change with respect to the centre frequency of the selected multi-band.

An illustration of the waveform shapes at different stages in the alternative transmitter structure of FIG. 4(a) is given in FIG. 4(b). Waveform A shows the in-phase data stream and waveform B shows the quadrature data stream. Waveform C shows the pulse train produced by the pulse generator. Waveform D shows the pulse train after modulation by the in-phase data stream and waveform E shows the pulse train after modulation by the quadrature data stream, the polarity of the modulated pulses indicates the current level of the modulating data stream.

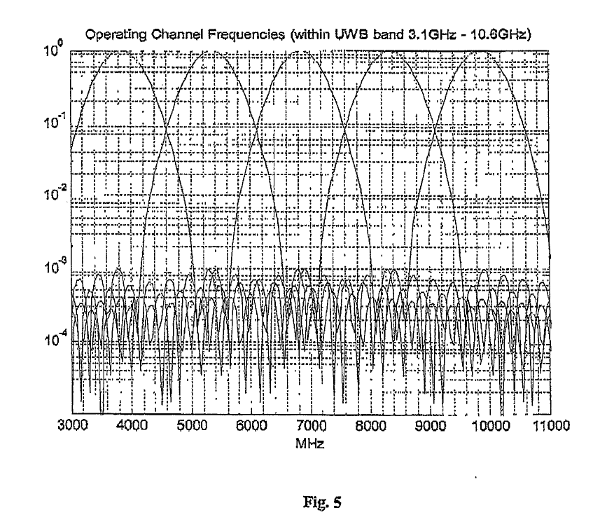

The system illustrated in FIG. 4(a) allows transmission in multiple bands. An example of this multi-band frequency allocation scheme is shown in FIG. 5. The frequency spectrum allocated for UWB transmission by FCC (3.1-10.6 GHz) is split into 5 bands, with centre frequencies of 3850 MHz, 5350 MHz, 6850 MHz, 8350 MHz and 9850 MHz.

It is known that wireless local area network (LAN) standard (IEEE 802.11a) uses around 5 GHz band. By eliminating the second band (4600 MHz-6100 MHz) in the given frequency allocation, it is possible to avoid interference due to the above wireless LAN standard. Furthermore, with a multi-band system, adjacent piconets can use different bands without significantly interfering with each other. Therefore, such a multi-band system may have improved coexistence and interference rejection properties than a single band system.

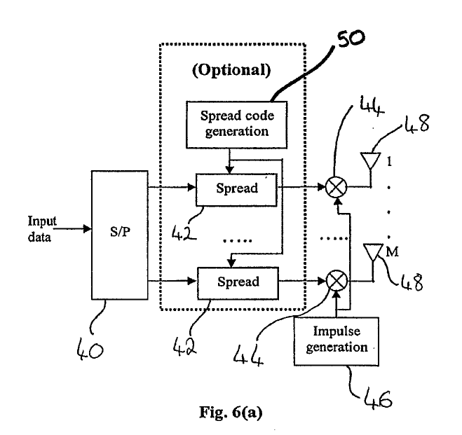

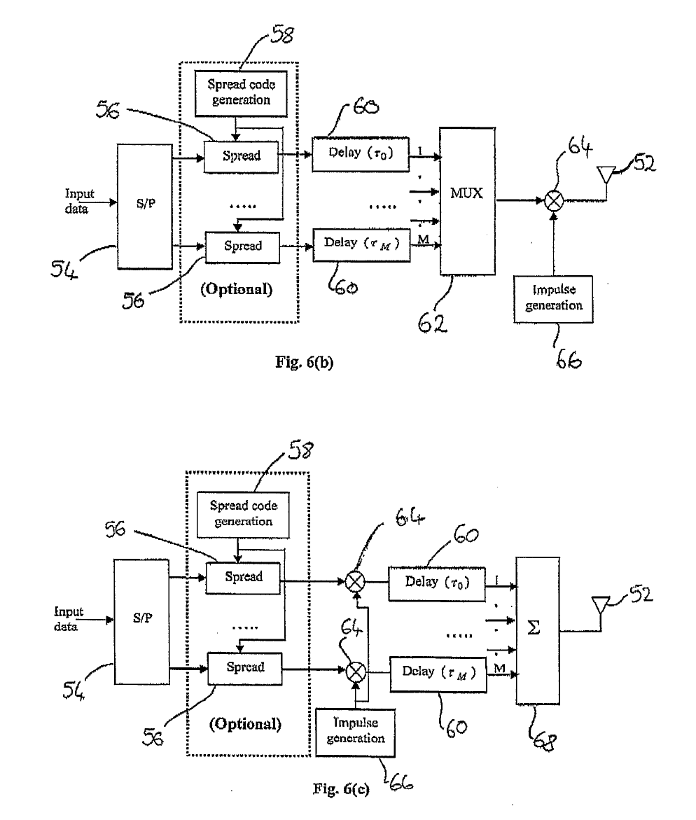

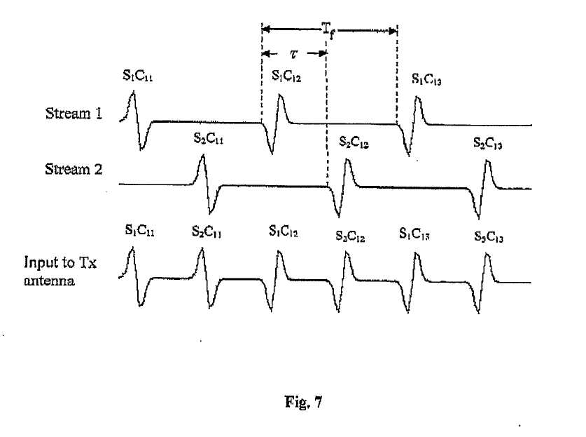

The combination of multiple transmitting antennae with advanced signal processing algorithms is a common practice for increasing transmission data rate in conventional communication systems. FIG. 6(a) shows the details of a conventional transmitter structure using multiple transmitting antennae for UWB transmissions. The transmitter comprises a serial-to-parallel converter 40 for converting the incoming data stream from serial mode to parallel data streams, the number of streams corresponding to the number of transmitting antennae. Each of the parallel data outputs from the converter 40 may be passed to a dedicated code spreader unit 42 and then to modulator units 44 driven by a pulse generator 46. Each parallel data output has a dedicated modulator unit 44 and antenna 48. The code spreader units 42 are driven by a spread code generator 50. The application of direct sequence spreading aims to avoid multiple access interference and to improve performance. However, in an alternative preferred embodiment (not shown), the code spreader units 42 and the generator 50 for driving these units 42 may be omitted.

If the system uses spreading, each data stream is independently spread using the same spread code and transmitted through separate antennae 48 after conversion into pulse trains via the pulse generator 46. The pulse generator 46 restricts the transmitted data to the required bandwidth and will generate short duration pulses (mono pulses) with a pre-specified pulse width followed by a long space region as shown in FIG. 2(a). As peak-to-average power is a constant parameter in ultra wideband radio, the peak amplitude of the pulse is directly related to the interval between pulses.

The schematic block diagram for a staggered transmitter according to a preferred embodiment of the invention is given in FIG. 6(b). Unlike the conventional transmission system shown in FIG. 6(a), the staggered transmission system uses a single antenna 52. The transmitter comprises a serial-to-parallel converter 54 for converting the incoming data stream from serial mode to parallel data streams, the number of streams corresponding to the number of transmitting antennae. Each of the parallel data outputs from the converter 54 may be passed to a dedicated code spreader unit 56, the spreader units 56 being driven by a spread code generator 58. The data from different transmission streams are delayed with respect to each other in delay units 60 and multiplexed together in a multiplexer 62 before transmission. The multiplexed data stream is converted into a pulse trains in a modulator 64 driven by a pulse generator 66 and then transmitted. The relative delay between transmission streams is kept constant.

As mentioned above, the application of direct sequence spreading aims to avoid multiple access interference and to improve performance. However, in an alternative preferred embodiment (not shown), the code spreader units 56 and the generator 58 for driving these units 56 may be omitted.

An alternative structure for the staggered transmitter according to a further preferred embodiment is provided in FIG. 6(c). The basic difference between FIG. 6(b) and FIG. 6(c) is the position of the pulse generator 66 and the multiplexer 62. In FIG. 6(b), the parallel data streams are delayed, time multiplexed and then converted into pulses. By contrast, in FIG. 6(c), each stream is converted into pulse trains in a dedicated modulator 64, delayed in a dedicated delay unit 60 and then the data streams are added together in an adding unit 68 before being transmitted.

The timing constraints for staggered transmission are
The incoming data sequence is split into parallel data streams (consider M parallel streams), each being spread independently and converted to pulse trains, they are referred as transmission streams.
The delay of the first transmission stream (τ₀) is set to zero.
The relative delays between adjacent transmission streams are kept constant (that is, τ₁−τ₀=τ₂−τ₁= . . . =τ_{M-2}−τ_{M-1}=τ).
The delay of the last transmission stream should be less than pulse repetition period. More precisely, the difference between the pulse repetition period and the delay of the last transmission stream should be equal to the relative delay, τ (that is, T_{f}−τ_{M-1}=τ where T_{f} is the pulse repetition period).
The maximum number of parallel streams (M) should be less than or equal to the ratio of pulse repetition period to pulse width (that is, M≦T_{f}/Tₚ where Tₚ is the pulse width).

An illustration of waveforms generated during staggered transmission according to an embodiment of the invention is shown in FIG. 7. Two parallel streams S₁ and S₂ are used. Assuming spreading with a chip sequence of (C₁₁, C₁₂, . . . ) for user 1, each monoshot in the figure corresponds to a chip. For example, the monoshot S₁C₁₁ corresponds to stream 1 chip C₁₁. As there are only two streams in FIG. 7, the relative delay between streams is half of the pulse repetition period. The relative delay will depend on the number of parallel streams. The input to the transmitter antenna is the sum of both streams, as shown in FIG. 7.

Using staggered transmission, it is possible to increase transmission data rate without increasing the oversampling rate at the receiver, by increasing the number of parallel streams and multiplexing them together with a smaller relative delay. The maximum data rate one can achieve is determined by the pulse width Tₚ and the minimum resolvable delay τ. However, the reduction in the relative delay will have a direct impact on length of interval between pulses and thereby increase multipath interference. As mentioned before, the use of higher modulation schemes for the transmitted data can further enhance the transmission rate.

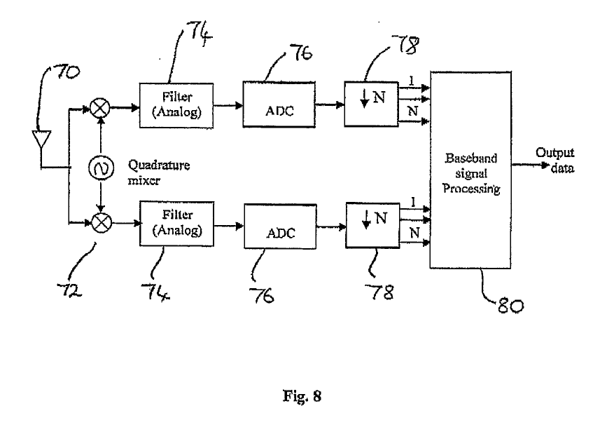

The receiver structure of a system according to a preferred embodiment is shown in FIG. 8. The signal received via a receiving antenna 70 will have multipath components and is most probably embedded in noise. As discussed above, the best option to capture the received signal energy is to design a filter matched to the received pulse shape, which may be achieved by a local oscillator (LO) based receiver.

To compensate for the timing mismatch and small delay components due to oversampling, the received signal is processed using a quadrature mixer 72 operating at a very high frequency (which should be equal to the inverse of the pulse width for accurate detection) to separate the signal into an in-phase signal and a quadrature signal.

The separated in-phase and quadrature phase (I-Q) signals are each passed through a low pass filter 74, then an analogue-to-digital converter (ADC) 76 and to a serial-to-parallel conversion unit 78. Each signal has its own filter 74, ADC 76 and serial-to-parallel conversion unit 78, these units being in parallel with the corresponding units of the other signal, as shown in FIG. 8.

The ADCs 76 are sampled at a high rate, which is fixed as N times the pulse repetition period. The resulting N-times oversampled data stream is converted to N parallel streams, each operating at the pulse repetition period (chip period if spreading be used). A base band signal-processing unit 80 processes these N parallel data streams, generated from both I-phase and Q-phase, for channel equalization and subsequent decoding.

In an embodiment such as that illustrated in FIG. 8, the receiver system can achieve a temporal diversity of the order N. The diversity gain obtained by this oversampling receiver structure is similar to the receiver diversity gain obtained by employing multiple receiving antennae. Compared to space diversity, the proposed system has a simplified receiver structure with fewer LOs and ADCs, but the ADC sampling rate is N times higher than the alternative methods.

Another point to note is that by employing staggered transmission together with an oversampling receiver, one effectively reduces the channel dispersion by a factor of N. An efficient baseband signal-processing unit 80 can exploit this feature and improve the performance.

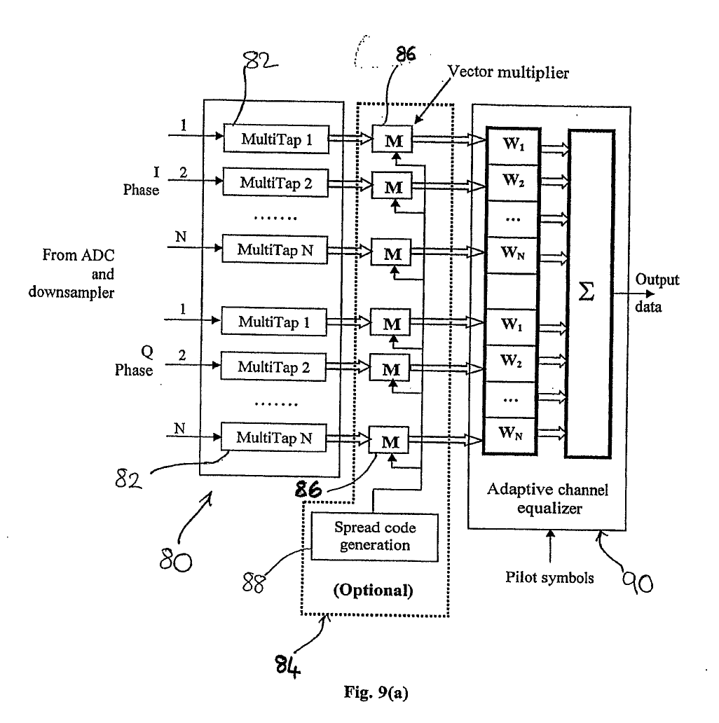

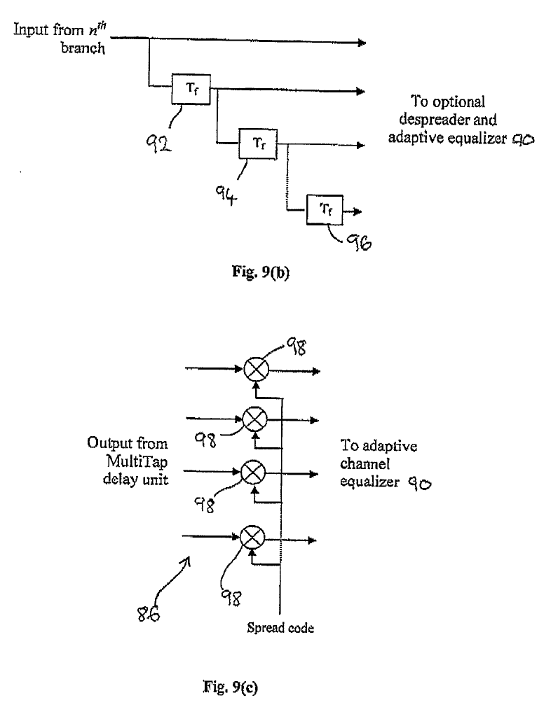

The details of baseband signal processing unit 80 used by the proposed receiver structure shown in FIG. 8 are shown in FIG. 9(a). Each of the N parallel streams is passed through a respective multi-tap delay unit 82, the delay units 82 being arranged in parallel. If the signals were spread at the transmitter, the outputs of the delay units 82 are passed to a despreader 84. The despreader 84 consists of a vector multiplier unit (M) 86 for each multi tap delay unit 82, which multiplies the multi-tap output with the respective spread code values. The vector multiplier units 86 are driven by a spread code generator 88.

After despreading, the respective I-phase and Q-phase outputs are passed to a pilot-assisted adaptive channel equalizer unit 90 for equalization. The channel equalizer unit 90 has a weight vector W and comprises a plurality of parallel units. Each parallel unit processes multiple taps delayed by the pulse repetition period (chip period in case of spreading) to improve the performance of adaptive equalizer unit 90. The system illustrated in FIG. 9(a) uses a space-time channel equalizer with multiple taps for channel equalization. A recursive least square (RLS) algorithm, with CORDIC architecture, would be suitable for use as the equalizer 90 due to its modular, pipelined systolic architecture. More details of RLS equalizers are available in the book Adaptive Filter Theory by S. Haykin, 3^{rd} Edition, Prentice-Hall Inc, New Jersey, 1996, Page Nos: 508-570.

In a further preferred embodiment (not shown), the despreader 84 may be omitted.

FIG. 9(b) shows the details of the multi-tap (MultiTap) delay unit 82 of FIG. 9(a). Each of the N parallel streams from the ADCs 76 and serial-to-parallel conversion units 78 of the system of FIG. 8 is passed directly to an input of either the adaptive equalizer 90 or the despreader 84 if fitted. Each stream is also delayed by one pulse repetition period (T_{f}), in a delay unit 92 and the output of the delay unit 92 is passed to another input of the adaptive equalizer 90 or the despreader 84. Each delayed stream is also delayed by a further one pulse repetition period (T_{f}), in another delay unit 94 and the output is passed to another input of the adaptive equalizer 90 or the despreader 84 as well as to a further delay unit 96. The structure is repeated N times.

The multiple tap delay units 82 are provided to improve the system performance. The number of taps required is a system parameter, and this together with the oversampling factor of the receiver determines the hardware complexity of the adaptive equalizer unit 90.

FIG. 9(c) shows the details of the vector multiplier unit (M) 86 of FIG. 9(a). The function of this unit is to multiply the multi-tap delayed output by the respective spread code values. Each output from the multi-tap delay unit 82 is passed to a multiplier unit 98 where it is multiplied by the appropriate spread code from a spread code generator (not shown). The output of the multiplier 98 is passed to an input of the adaptive channel equalizer 90.

To reduce the hardware cost and complexity of the receiver of an embodiment of the invention, the applicants have experimented with ADCs having fewer bits. From the simulation studies, they have noted that single-bit and two-bit ADCs can be used successfully without significantly degrading performance. The simulation studies discussed in the following section demonstrate the performance of the single-bit ADC.

The system embodying the invention has been simulated extensively for different channel parameters. To conduct simulation studies, the transmitted signal has to pass through a wireless communication channel, which is characterized by a frequency selective multipath fading channel. The system embodying the invention assumes a UWB channel model derived from the Saleh-Valenuela model (More details are given by A Saleh, R. Valenzuela, in “A statistical model for indoor multipath propagation” published in IEEE Journal on Selected Areas in Communications, Vol. SAC-5, No. 2, February 1987, pp. 128-137), with a couple of slight modifications noted by the IEEE P802.15 working group for wireless personal area networks. More details are given in IEEE P802.15 Working Group for Wireless Personal Area Networks, “Channel Modeling Sub-Committee Final Report”, Document No: IEEE P802.15-02/368r5-SG3a, December 2002), the disclosure of which is incorporated herein by reference.

The channel model embodying the invention is based on lognormal distribution rather than Rayleigh distribution for multipath gain amplitude. The channel model consists of the following discrete time impulse response:

$${h}_{n , m}^{( k )} ( t ) = {\sum }_{l = 0}^{C} {\sum }_{p = 0}^{P} {h}_{n , m}^{( k )} ( l , p ) δ ( t - {T}_{l} - {τ}_{p , l} )$$

where h_{m,n}^{(k)}(l,p) is the multipath gain coefficient, Tₗ is the delay of l^{th} cluster, and τ_{p,l} is the delay of p^{th} multipath component relative to l^{th} cluster arrival time (Tₗ). The multipath coefficients are considered as uncorrelated for all k, m, n, l and p.

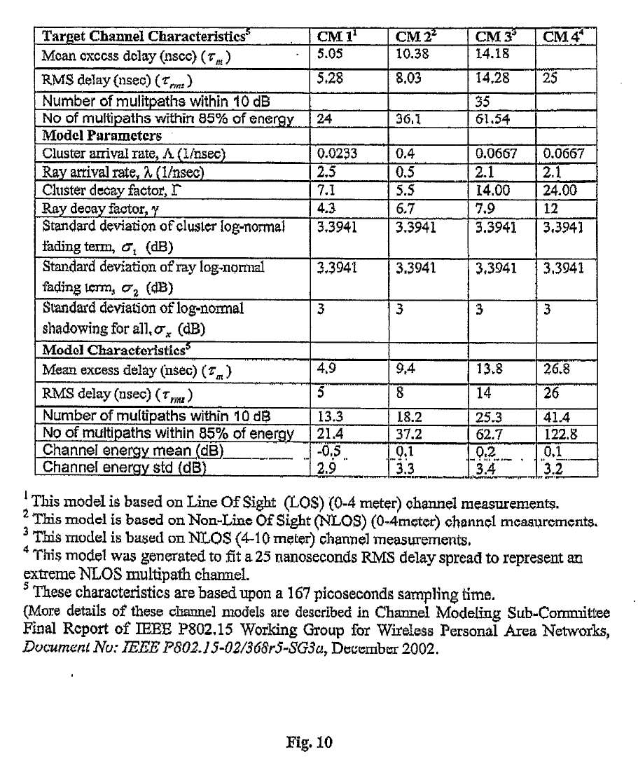

The channel model proposed/selected in the IEEE 802.15 High Rate Alternative PHY Study Group (SG3a) for Wireless Personal Area Networks (WPANs™) is used for the simulation studies. FIG. 10 is a table illustrating the multipath channel characteristics and corresponding model parameters proposed by IEEE P802.15 Working Group for Wireless Personal Area Networks, “Channel Modeling Sub-Committee Final Report”, Document No: IEEE P802.15-02/368r5-SG3a, December 2002 for the simulation studies of high-rate WPAN devices. The simulation studies of the embodiments of the invention described herein have been conducted using these channel models.

The simulation system uses QPSK for data modulation and uses two parallel transmitted streams. The system performance is analysed with two different oversampling factors (16 and 32). The receiver uses an RLS equalizer, efficiently implemented using a systolic array architecture. To improve the system performance, the applicants have used many delay taps for the RLS structure. The simulation studies considered two 2-tap delay and 4-tap delay structures.

The data and pilot symbols are time multiplexed. The pilot symbols uses ¼th rated Walsh-Hadamard code for channel coding and orthogonal spreading with a processing gain of 4. The data is not spread to achieve maximum data rate possible.

The receiver of the system embodying the invention is tested with floating point (without any quantization during digital-to-analog conversion) and single-bit ADC. The single-bit ADC performance is analysed for the practical implementation of the system due to the availability and cost considerations of ADCs with very high sampling rates. The data streams are not spread, but use the same channel coding.

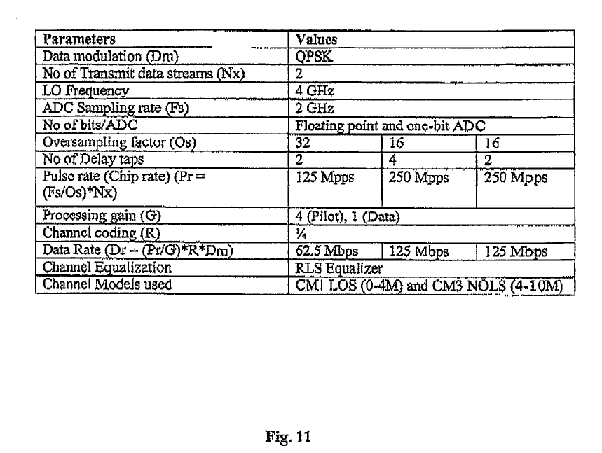

The table given in FIG. 11 describes all the simulation parameters used in this simulation study.

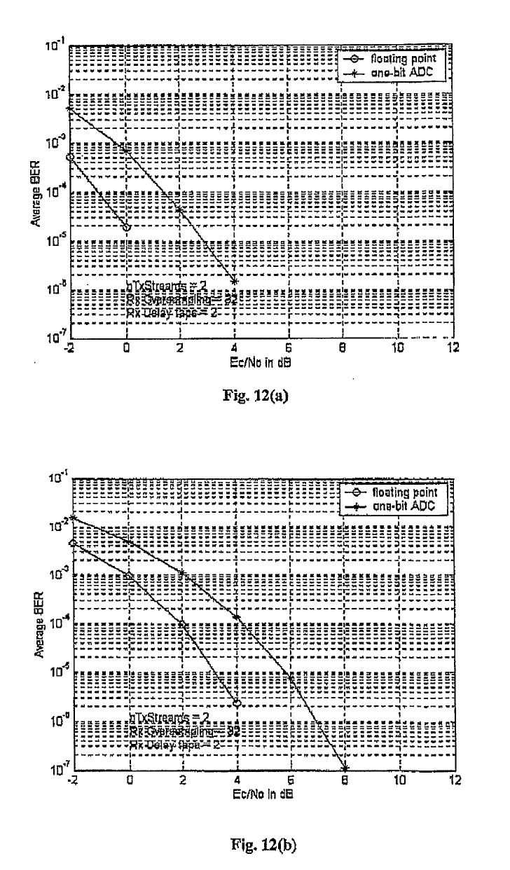

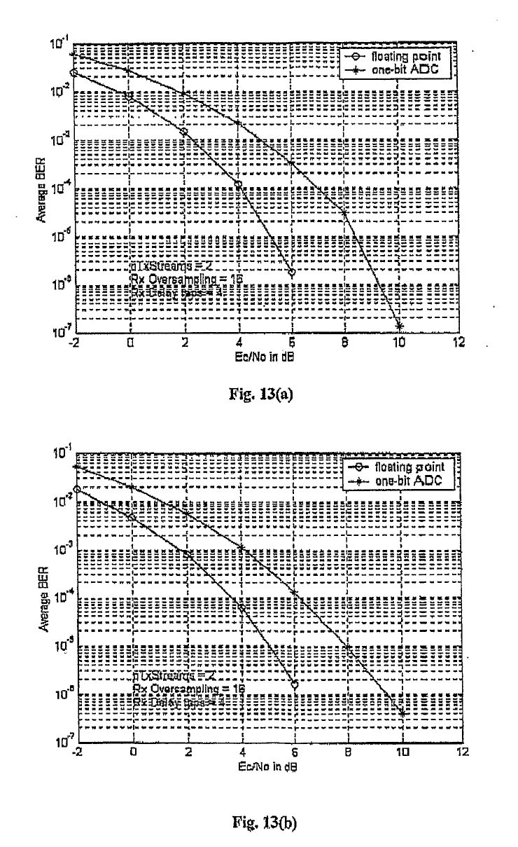

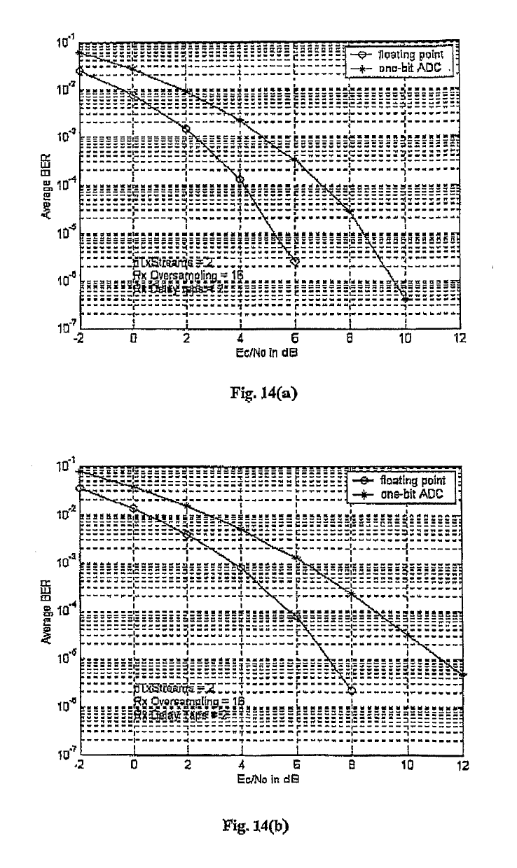

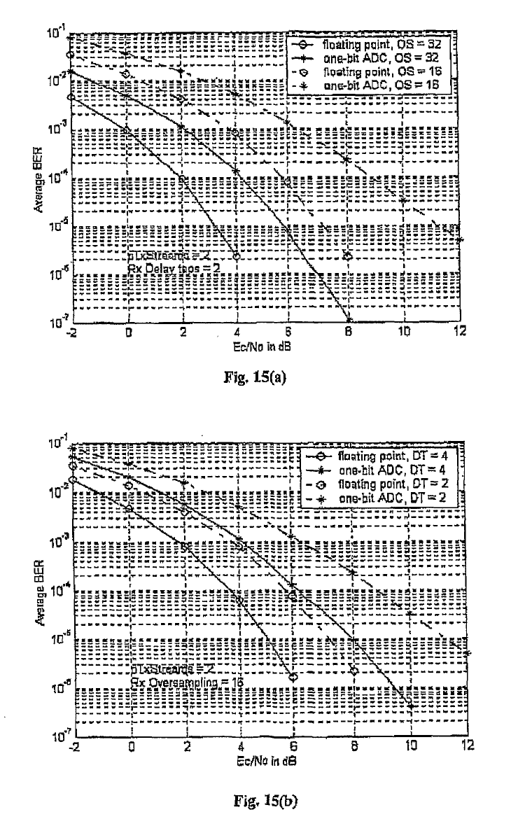

The BER performance of a system embodying the invention is given in FIGS. 12, 13 and 14. Performances are plotted for both line of sight (LOS) (Channel model 1, CM1) and non-line of sight (NLOS) (Channel Model 2, CM2) channel models proposed by IEEE study group. FIG. 12 corresponds to the performance of the system with an oversampling factor of 32 with two delay taps for RLS equalizer. FIGS. 13 and 14 correspond to the performance of oversampling factor 16 with delay taps 4 and 2 respectively. FIGS. 15 (a) and 15(b) show a comparative performance against different receiver parameters. FIG. 15(a) shows the performance improvement obtained by increasing the oversampling factor at receiver and FIG. 15(b) shows the performance improvement of the system with more delay taps.

UWB transmission technology is considered a suitable candidate for ultra high data rate short-range indoor communication applications due to its extremely large frequency band and the low power spectral density of the signal. In this context, this invention is examining possible methods for high rate data transmission.

One of the simplest ways to increase the data rate of any communication system is to use higher modulation during transmission. Conventionally, UWB systems use BPSK modulation, due to its low mark/space ratio. As the preferred systems of the present invention use a local oscillator receiver structure, higher modulation methods may be employed at the transmitter. However, due to the higher noise levels of the UWB transmissions, the amplitude levels may be distorted and higher amplitude modulations such as 16QAM may not work satisfactorily.

To overcome or avoid such problems, in a preferred embodiment QPSK modulation is preferred for data modulation. Unlike BPSK, where a single pulse is used, QPSK uses two pulses, which are separated by a quarter cycle shift (of a UWB pulse). This quarter cycle shift introduces a 90 degree phase shift between the pulses.

The transmitter using the pulse generating methods discussed in the above paragraph (QPSK) is suitable for transmitting UWB pulses in a single band. Due to the wide bandwidth of the transmitted signal, UWB signal energy will spread over the frequency bands allocated to other radio systems, such as cellular phones, broadcasting, etc. Hence the coexistence of multiple wireless standards together with UWB systems is an important issue to be addressed.

Splitting the available large bandwidth into multiple bands is a possible solution for the problems relating to coexistence and interference from adjacent piconets. Multi-band transmitters using local oscillators can implement this. Furthermore, if multiple bands be used for a single device, the data transfer rate can increase considerably at the cost of higher transmitter complexity. To achieve multi-band transmission, the pulse generation unit discussed in the FIG. 3 should be replaced with a modified multi-band transmitter incorporating local oscillators. However, this modification is optional and is useful for transmitting pulses through multiple frequency bands. The oscillator for this method will be programmable and should have minimum switching delay, as this will help the user to avoid frequency bands in use at adjacent piconets and will help to avoid frequency bands used by other wireless standards.

As shown in FIG. 2(a), the signal is transmitted through each antenna after generating mono pulses of pre-specified pulse width. The transmitted signal corresponding to the m^{th} antenna of k^{th} user can be expressed as follows:

x_{k,m}(t)=\sqrt{p_{k,m}}d_{k,m}(t)cₖ(t)wₜᵣ(t)

where p_{k,m} is the transmitted signal power and d_{k,m} is the binary data corresponding to m^{th} antenna of k^{th} user with a symbol period of Tₛ. Likewise, cₖ is the optional spread code corresponding to the user k with a chip period of T_{f} (processing gain of the system G=Tₛ/T_{f}) and wₜᵣ represents pulse train of the form

$${\sum }_{j = - ∞}^{+ ∞} {u}_{tr} ( {t}^{( k )} - {jT}_{f} ) ,$$

consisting of mono pulses spaced at the chip period (which is also the same as the pulse repetition period). The chip period and the symbol period are the same for systems without spreading. This transmitter model would have a very low duty cycle.

Using multiple antennae will increase the complexity of the transmitter considerably due to the complexities in RF design. The low mark/space ratio of UWB pulses is in contrast with the conventional MIMO systems, where chips are equally spaced for transmission without any gaps in between. The transmitter structure can be modified considerably by exploiting this feature of UWB transmission. Instead of sending parallel data streams through different antennae as shown in FIG. 6(a), the transmission diversity can be obtained by a staggered transmission method using a single antenna.

The receiver performance of preferred embodiments of the invention may be improved by employing an oversampling receiver structure such as that shown in FIG. 8. In such a system, the ADC is sampled at a higher rate.

The sampling rate is usually an integer multiple of the pulse repetition period. This oversampled data stream is converted to parallel streams, and each stream operates at the pulse repetition frequency. The baseband signal-processing unit processes these streams in parallel to generate signals for adaptive channel equalization and coding so that the receiver can achieve temporal diversity.

Thus the systems embodying the invention introduce diversity gains at both transmitter and receiver, and will help to improve the system capacity considerably. To accommodate multiple accesses, the systems can optionally use code division multiple access technology. Selecting higher modulation such as QPSK can increase data transmission rate further.

Various modifications to the embodiments of the present invention described above may be made. For example, other modules and method steps can be added or substituted for those above. Thus, although the invention has been described above using particular embodiments, many variations are possible within the scope of the claims, as will be clear to the skilled reader, without departing from the spirit and scope of the invention.

1. A transmitter system for transmitting data as a pulsed ultrawide band signal comprising:
a converter for converting a signal to be transmitted from a serial sequence to a parallel sequence;
a modulator to convert said parallel sequence to a parallel stream of impulse trains, each train having a pulse repetition period,
a delay unit to delay said parallel streams of impulse trains by different time intervals within the same pulse repetition period,
a signal combining unit to combine the delayed pulse streams to form a combined signal so that the pulses in the streams occur within the pulse repetition period of a single pulse;
a pulse generator to form a pulse sequence based on said combined signal; and
an antenna for transmitting said pulse sequence.

2. A system according to claim 1, further comprising a spreader coupled to said first converter for receiving said parallel sequence and for spreading said parallel sequence.

3. A system according to claim 1, further comprising a plurality of spreader units, each spreader unit being coupled to said first converter for receiving a parallel sequence and for spreading said parallel sequence.

4. A system according to claim 1 wherein said modulator has an input and an output, said input being connected to said signal combining unit and said output being connected to said antenna.

5. A system according to claim 1 wherein said modulator has an input and an output, said input being connected to said converter and said output being connected to said delay unit.

6. A system according to claim 1 comprising a delay unit for each stream.

7. A system according to claim 2, further comprising a spread code generator to drive said spreader unit.

8. A receiver system for receiving data as a pulsed ultrawide band signal comprising:
a receiving antenna for receiving said pulsed ultrawide band signal, said pulsed signal having a pulse shape, a bandwidth, a pulse width, and a pulse repetition frequency, said pulsed signal comprising two or more interleaved pulse trains having equal pulse repetition periods, said interleaved pulse trains being spaced by a pulse spacing, said pulse repetition period being greater than said pulse spacing,
a matched filter coupled to said antenna for filtering said received signal to form a filtered signal, said filter being matched to the pulse shape of said received signal,
a low-pass filter coupled to said matched filter to process said filtered signal to form a processed signal;
an analogue-to-digital converter coupled to said low-pass filter to convert, at a rate greater than the pulse repetition frequency of said received signal, said processed signal from an analogue signal to a digital signal;
a serial-to-parallel conversion unit coupled to said converter to convert said digital signal to produce N parallel sampled signals, and
a signal processor coupled to said serial-to-parallel conversion unit to produce an output signal representative of said received data.

9. A system according to claim 8, wherein said receiver matched filter is a sinusoidal waveform.

10. A system according to claim 10, wherein said receiver matched filter is a local oscillator having a centre frequency equal to the inverse of the pulse width.

11. A system according to claim 8, wherein said low-pass filter has a bandwidth substantially equal to the bandwidth of said pulse.

12. A system according to claim 8, further comprising a quadrature mixer coupled between said receiving antenna and said matched filter for separating in-phase and quadrature pulse chains from said received signal.

13. A system according to claim 12, further comprising a plurality of matched filters, and/or analogue-to-digital converters, and/or serial-to-parallel conversion units, each pulse chain having a respective matched filter, and/or analogue-to-digital converter, and/or serial-to-parallel conversion unit.

14. A system according to claim 12, wherein said quadrature mixer is arranged to operate at a frequency substantially equal to the inverse of the pulse width.

15. A system according to claim 8, wherein said signal processor comprises N delay units for receiving said N parallel sampled signals, each of said N delay units being arranged to delay one of said N parallel sampled signals by one or more pulse repetition periods.

16. A system according to claim 15, wherein said N delay units comprise a series of multi-tap delay networks for selecting a predetermined pulse stream from said received pulsed signal.

17. A system according to claim 16, wherein said signal processor further comprises a channel equalizer having an input coupled to one or more outputs of said one or more delay units for equalizing one or more channels in said predetermined pulse stream to form an output signal representative of said received data.

18. A system according to claim 17, wherein said channel equalizer is arranged to apply a recursively square algorithm to said predetermined pulse stream.

19. A system according to claim 15, further comprising a despreader coupled between said one or more delay units and said channel equalizer to despread said delayed signal.

20. A system according to claim 17, wherein said channel equalizer is a pilot-assisted adaptive channel equalizer.

21. A transceiver system comprising a transmitter for transmitting data as a pulsed ultrawide band signal comprising:
a converter for converting a signal to be transmitted from a serial sequence to a parallel sequence;
a modulator to convert said parallel sequence to a parallel stream of impulse trains, each train having a pulse repetition period,
a pulse generator to drive said modulator,
a delay unit to delay said parallel streams of impulse trains by different time intervals within the same pulse repetition period;
a signal combining unit to combine the delayed pulse streams to form a combined signal so that the pulses in the streams occur within the pulse repetition period of a single pulse; and
an antenna for transmitting said combined signal, said transceiver system further comprising:
a receiver for receiving data as a pulsed ultrawide band signal comprising:
a receiving antenna for receiving said pulsed ultrawide band signal, said pulsed signal having a pulse shape, a bandwidth, a pulse width, and a pulse repetition frequency, said pulsed signal comprising two or more interleaved pulse trains having equal pulse repetition periods, said interleaved pulse trains being spaced by a pulse spacing, said pulse repetition period being greater than said pulse spacing,
a matched filter coupled to said antenna for filtering said received signal to form a filtered signal said filter being matched to the pulse shape of said received signal;
a low-pass filter coupled to said matched filter to process said filtered signal to form a processed signal,
an analogue-to-digital converter coupled to said low-pass filter to convert said processed signal from an analogue signal to a digital signal;
a serial-to-parallel conversion unit coupled to said converter to sample said digital signal at a rate greater than the pulse repetition frequency of said received signal and to produce a sampled signal; and
a signal processor coupled to said serial-to-parallel conversion unit to produce an output signal representative of said received data.

22. A DS-CDMA system comprising the transmitter of claim 1.

23. A DS-CDMA system comprising the receiver of claim 8.

24. A DS-CDMA system comprising the transceiver of claim 21.

25. A method for transmitting data as a pulsed ultrawide band signal comprising:
converting in a serial-to-parallel converter a signal to be transmitted from a serial sequence to a parallel sequence,
converting in a modulator said parallel sequence to a parallel stream of impulse trains, each train having a pulse repetition period;
delaying said parallel streams of impulse trains by different time intervals within the same pulse repetition period,
combining the delayed pulse streams to form a combined signal so that the pulses in the streams occur within the pulse repetition period of a single pulse, and transmitting said combined signal.

26. A method according to claim 25, further comprising spreading in a spreader said parallel sequence after the step of converting said signal to be transmitted from a serial sequence to a parallel sequence.

27. A method according to claim 25, wherein the step of converting in a modulator said parallel sequence is after the steps of delaying said parallel streams and combining the delayed pulse streams.

28. A method according to claim 25, wherein the step of converting in a modulator said parallel sequence is before the steps of delaying said parallel streams and combining the delayed pulse streams.

29. A method for receiving data as a pulsed ultrawide band signal comprising:
receiving said pulsed ultrawide band signal, said pulsed signal having a pulse shape, a bandwidth, a pulse width, and a pulse repetition frequency, said pulsed signal comprising two or more interleaved pulse trains having equal pulse repetition periods, said interleaved pulse trains being spaced by a pulse spacing, said pulse repetition period being greater than said pulse spacing;
filtering in a matched filter said received signal to form a filtered signal, said filter being matched to the pulse shape of said received signal;
processing in a low-pass filter coupled to said matched filter said filtered signal to form a processed signal,
converting said processed signal from an analogue signal to a digital signal;
serial-to-parallel converting said digital signal at a rate greater than the pulse repetition frequency of said received signal and to produce a sampled signal, and
processing said sampled signal to produce an output signal representative of said received data.

30. A method according to claim 29, further comprising separating in-phase and quadrature pulse chains from said received signal.

31. A method according to claim 29, wherein the step of processing the sampled signal comprises delaying said sampled signal by one or more pulse repetition periods.

32. A method according to claim 31, wherein the step of processing the sampled signal further comprises selecting a predetermined pulse stream from said received pulsed signal.

33. A method according to claim 29, wherein the step of processing the sampled signal comprises equalizing one or more channels in said predetermined pulse stream to form an output signal representative of said received data.

34. A method according to claim 33, wherein the step of equalizing comprises applying a recursively square algorithm to said predetermined pulse stream.

35. A method according to claim 29, further comprising despread said delayed signal.
